(19) United States
(12) Patent Application Publication
(10) Pub. No.: US 2025/0227698 A1
(43) Pub. Date: Jul. 10, 2025

(54) METHOD AND APPARATUS FOR ENHANCEMENTS ON PHYSICAL DOWNLINK CONTROL CHANNEL (PDCCH) MONITORING ADAPTATION

(71) Applicant: MEDIATEK INC., Hsinchu City (TW)

(72) Inventors: Yi-Chia LO, Hsinchu City (TW); Wei-De WU, Hsinchu City (TW); Chi-Hsuan HSIEH, Hsinchu City (TW); Yi-Ju LIAO, Hsinchu City (TW)

(21) Appl. No.: 18/724,334

(22) PCT Filed: Jan. 6, 2023
(86) PCT No.: PCT/CN2023/070910

§ 371 Date: Jun. 26, 2024

Related U.S. Application Data
(60) Provisional application No. 63/298,352, filed on Jan. 11, 2022.
(60) Provisional application No. 63/336,349, filed on Apr. 29, 2022.

(51) Int. Cl. H04W 72/1273; H04L 1/1812; H04W 72/0457; H04W 72/231

(52) U.S. Cl. CPC H04W 72/1273; H04L 1/1812; H04W 72/0457; H04W 72/231

(57) ABSTRACT

Various solutions for enhancements on physical downlink control channel (PDCCH) monitoring adaptation are described. An apparatus may detect a scheduling downlink control information (DCI) format from a network node of a wireless network. The scheduling DCI format indicates a duration for skipping PDCCH monitoring. The apparatus may perform PDCCH monitoring based on a setting of a new active downlink (DL) bandwidth part (BWP) in a case that the apparatus changes to the new active DL BWP by an expiration of a BWP inactive timer in the duration.

### CROSS REFERENCE TO RELATED PATENT APPLICATION(S)

The present disclosure claims the priority benefit of U.S. Provisional Patent Application No. 63/298,352, filed on 11 Jan. 2022 and U.S. Provisional Patent Application No. 63/336,349, filed on 29 Apr. 2022. The contents of aforementioned applications are herein incorporated by reference in their entirety.

### TECHNICAL FIELD

The present disclosure is generally related to mobile communications and, more particularly, to enhancements on physical downlink control channel (PDCCH) monitoring adaptation.

### BACKGROUND

Unless otherwise indicated herein, approaches described in this section are not prior art to the claims listed below and are not admitted as prior art by inclusion in this section.

Discontinuous reception (DRX) is a technique applied in wireless communication technologies, such as 4G long-term evolution (LTE) and 5G new radio (NR), to conserve system resources. In DRX operations, a user equipment (UE) generally performs wireless reception in a DRX ON duration, and switches to a power saving mode in a DRX OFF duration since the network will not be transmitting any data to the UE in the DRX OFF duration. Specifically, the UE needs to monitor the physical downlink control channel (PDCCH) in the DRX ON duration, to see if the network transmits any data to the UE. With DRX operations, the UE is allowed to go to sleep in the DRX OFF duration of each DRX cycle, which reduces the UE's power consumption.

For UEs operating in DRX operations, it is observed in the 5G NR Daily of Use (DOS) analysis that, most of the time, the PDCCH monitoring is performed without further data. That is, a UE may always monitor the PDCCH in the DRX ON duration, but the network may not have any data to transmit to the UE. Such PDCCH monitoring without further data may consume a large portion of UE's battery power, especially for the cases where data is configured with short inter-packet arrival time. Alternatively, for UEs not operating in DRX operations, the same issue of power consumption for PDCCH monitoring may occur. To solve this problem, in 3^{rd} Generation Partnership Project (3GPP) Release 17, a technique called PDCCH monitoring adaptation is introduced which allows a UE to be indicated to skip PDCCH monitoring for a duration. However, there is an issue that the UE behavior is indeterminate in the case where the UE changes bandwidth part (BWP) due to a BWP inactive timer being expired in the PDCCH skipping duration. In addition, there is another issue concerning the impact PDCCH monitoring adaptation may have on data scheduling performance, especially for retransmission requests. Therefore, solutions are sought to enhance PDCCH monitoring adaptation to address the aforementioned issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to physical downlink control channel (PDCCH) monitoring adaptation.

In one aspect, a method may involve an apparatus detecting a scheduling downlink control information (DCI) format from a network node of a wireless network, wherein the scheduling DCI format indicates a duration for skipping PDCCH monitoring. The method may also involve the apparatus performing PDCCH monitoring based on a setting of a new active downlink (DL) bandwidth part (BWP) in a case that the apparatus changes to the new active DL BWP by an expiration of a BWP inactive timer in the duration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising detecting, via the transceiver, a scheduling DCI format from a network node of a wireless network, wherein the scheduling DCI format indicates a duration for skipping PDCCH monitoring. The processor may also perform operations comprising performing, via the transceiver, PDCCH monitoring based on a setting of a new active DL BWP in a case that the apparatus changes to the new active DL BWP by an expiration of a BWP inactive timer in the duration.

In one aspect, a method may involve an apparatus detecting a scheduling DCI format from a network node of a wireless network, wherein the scheduling DCI format indicates a duration for skipping PDCCH monitoring. The method may also involve the apparatus resuming PDCCH monitoring in a case that a hybrid automatic repeat request (HARQ) negative acknowledgement (NACK) or an uplink (UL) data is transmitted in the duration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of DRX operations in accordance with the present disclosure.

FIG. 2 is a diagram depicting an example scenario showing issues in accordance with the present disclosure.

FIG. 3 is a diagram depicting an example scenario under schemes in accordance with implementations of the present disclosure.

FIG. 4 is a diagram depicting another example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on physical downlink control channel (PDCCH) monitoring adaptation. According to the present disclosure, a number of possible solutions may be implemented separately or jointly. That is, although these possible solutions may be described below separately, two or more of these possible solutions may be implemented in one combination or another.

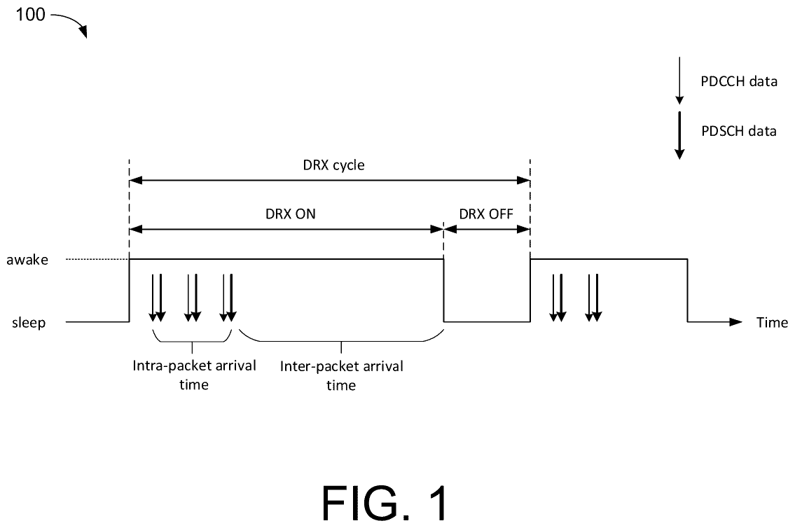

In 3^{rd} Generation Partnership Project (3GPP), a radio access network (e.g., 5G NR access network) may include a plurality of base stations (e.g., Next Generation Node-Bs (gNBs)) to communicate with a plurality of mobile stations referred as user equipment (UEs). Discontinuous reception (DRX) is a technique for UE power consumption reduction. In DRX operations, a UE generally performs wireless reception in a DRX ON duration, and switches to a power saving mode in a DRX OFF duration since the network will not be transmitting any data to the UE in the DRX OFF duration. FIG. 1 illustrates an example scenario 100 of DRX operations in accordance with the present disclosure. The DRX active time refers to the period of time in which a UE is awake, and the DRX active time may be determined based on parameters (e.g., DRX ON duration timer, DRX inactivity timer, and DRX retransmission timer, etc.) configured by a network node (e.g., a gNB/TRP) of a wireless network (e.g., a 5G NR network). As shown in scenario 100, the UE wakes up at the beginning of the DRX ON duration of each DRX cycle, and stays awake to monitor the PDCCH and receive downlink data packets, including PDCCH data packets and PDSCH data packets. Intra-packet period is usually caused by scheduling gap for fair scheduling among UEs or by beam sweeping pattern, and is generally in a shorter length when compared to inter-packet period. Inter-packet period is usually due to no data for the UE (i.e., end of data transmission), and is generally in a longer length when compared to intra-packet period.

In 3GPP Release 15 or Release 16, a UE needs to monitor the PDCCH at every slot unless it is in the DRX OFF duration. Later, in 3GPP Release 17, PDCCH monitoring adaptation is introduced to further reduce UE power consumption by allowing a UE to be indicated to skip (e.g., stop) PDCCH monitoring for a duration (e.g., for a certain number of consecutive slots). PDCCH monitoring adaptation is also called PDCCH skipping in the 3GPP Technical Specifications (e.g., TS 38.213) and it can be applied to both DRX scenarios (i.e., the scenarios in which the UE is operating in DRX operations) and non-DRX scenarios (i.e., the scenarios in which the UE is not operating in DRX operations). However, there are some issues/problems that may occur when applying PDCCH monitoring adaptation.

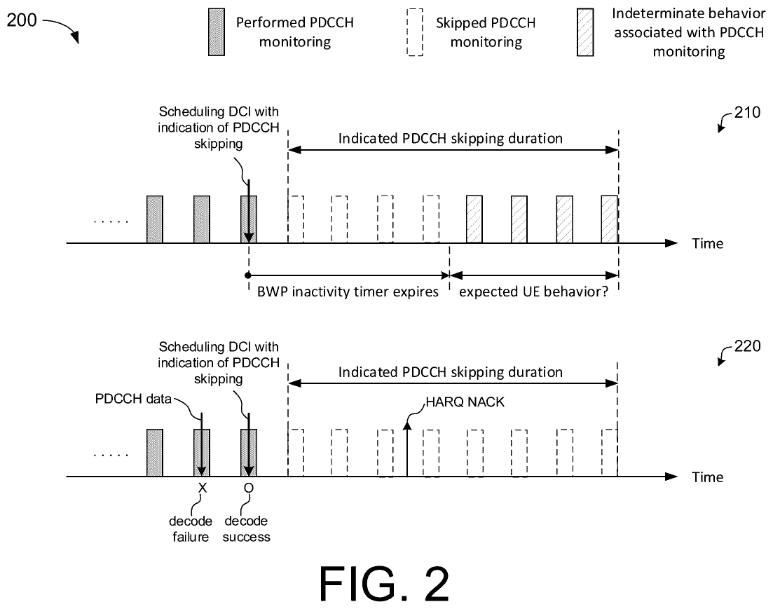

FIG. 2 illustrates an example scenario 200 showing issues in accordance with the present disclosure. As shown in scenario 200, top diagram 210 depicts a BWP switching event occurred in the PDCCH skipping duration, while bottom diagram 220 depicts a delayed retransmission request due to the PDCCH skipping duration. In diagram 210, after receiving a scheduling DCI (e.g., DCI format 0_1/1_1/0_2/1_2) with an indication of PDCCH skipping (e.g., an indication of a PDCCH skipping duration), the UE skips or stops PDCCH monitoring in the indicated PDCCH skipping duration. In the PDCCH skipping duration, the UE may need to switch BWP due to the expiration of a BWP inactivity timer. It should be noted that the UE behavior in the remaining period of time is indeterminate, which may lead to UE malfunction. In diagram 220, the PDCCH data which is received before the scheduling DCI with an indication of PDCCH skipping is not decoded successfully. In response to the decoding failure, the UE transmits a hybrid automatic repeat request (HARQ) negative acknowledgement (NACK) in the uplink (UL) direction. Unfortunately, the UE has to wait till the end of the PDCCH skipping duration, before it can be able to monitor PDCCH for the retransmitted PDCCH data. Likewise, if the UE needs to send UL data in the PDCCH skipping duration, it will only be able to receive the HARQ acknowledgement (ACK) or NACK after the PDCCH skipping duration. This will inevitably impact the data scheduling performance.

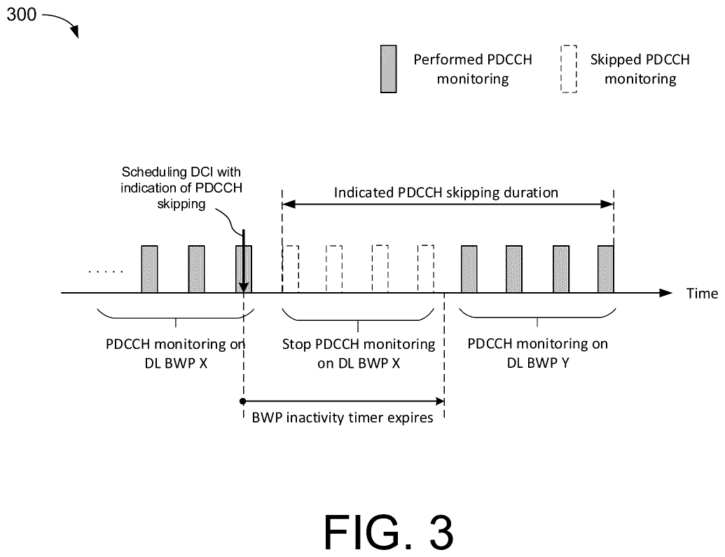

FIG. 3 illustrates an example scenario 300 under schemes in accordance with implementations of the present disclosure. As shown in scenario 300, the UE performs PDCCH monitoring on an active DL BWP (denoted as DL BWP X) of the serving cell. During the PDCCH monitoring, the UE receives a scheduling DCI (e.g., DCI format 0_1/1_1/0_2/1_2) with an indication of PDCCH skipping (e.g., an indication of a PDCCH skipping duration). In response to the scheduling DCI format with the indication, the UE skips or stops PDCCH monitoring on the active DL BWP. Subsequently, when a BWP inactivity timer expires in the PDCCH skipping 20 duration, the UE changes to a new active DL BWP (denoted as DL BWP Y). In response to the BWP switching, the UE performs PDCCH monitoring on the new DL BWP based on the setting of the new active DL BWP.

In some implementations, the PDCCH monitoring performed on the new DL BWP may include resuming PDCCH monitoring according to search space sets on the new active BWP in a case that a list of search space group identities (IDs) (e.g., searchSpaceGroupIdList-r17) is not configured.

In some implementations, the PDCCH monitoring performed on the new DL BWP may include monitoring PDCCH according to search space sets with group index 0 on the new active BWP of the serving cell in a case that the list of search space group IDs is configured.

In some implementations, the UE may, in response to the BWP switching, reset a search space set group (SSSG) timer (e.g., a search space switching timer) based on the setting of the new active DL BWP.

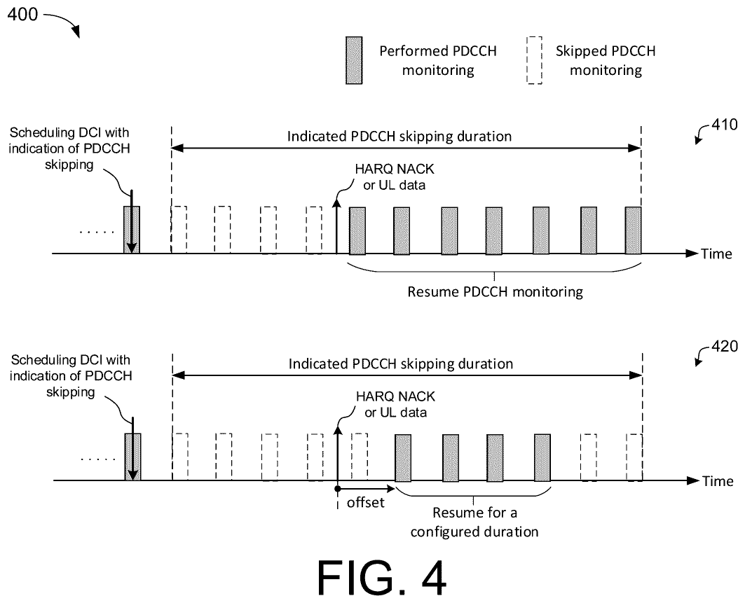

FIG. 4 illustrates an example scenario 400 under schemes in accordance with implementations of the present disclosure. As shown in diagram 410 of scenario 400, the UE skips or stops PDCCH monitoring in response to receiving a scheduling DCI (e.g., DCI format 0_1/1_1/0_2/1_2) with an indication of PDCCH skipping. Next, the UE transmits a HARQ NACK or an UL data in the PDCCH skipping duration. In response to the transmission of the HARQ NACK or the UL data, the UE resumes PDCCH monitoring in the PDCCH skipping duration. Alternatively, in diagram 420, the UE resumes PDCCH monitoring for a configured duration after a timing offset from the transmission of the HARQ NACK or the UL data.

In some implementations, the HARQ NACK is associated with a physical downlink shared channel (PDSCH) scheduled by the scheduling DCI format.

In some implementations, the UL data is transmitted on a physical uplink shared channel (PUSCH) scheduled by the scheduling DCI format.

In some implementations, the timing offset is used to align with DL or UL traffic.

In some implementations, the timing offset is set to 0.

### Illustrative Implementations

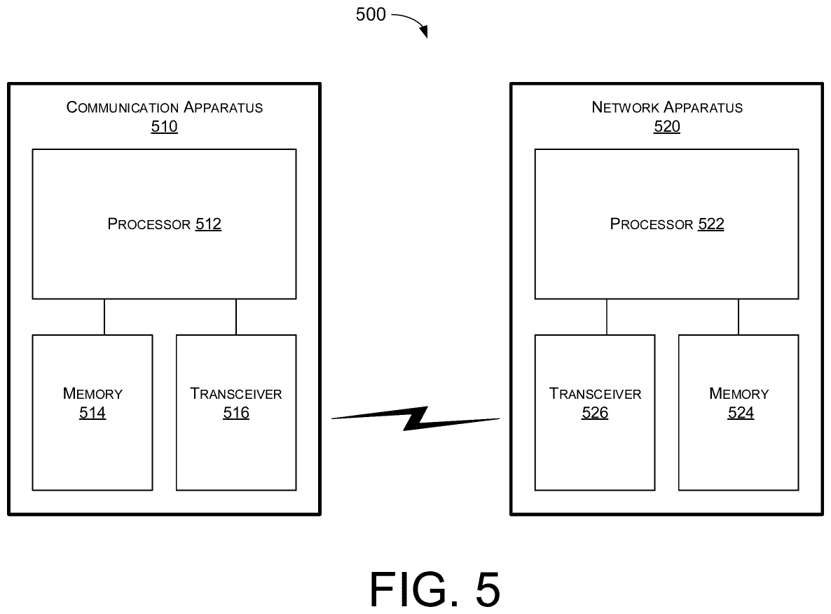

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to enhancements on PDCCH monitoring adaptation, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a base station, a small cell, a router or a gateway. For instance, network apparatus 520 may be implemented in an eNodeB in an LTE, LTE-Advanced or LTE-Advanced Pro network or in a gNB in a 5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, processor 512 may detect, via transceiver 516, a scheduling DCI format from the network apparatus 520, wherein the scheduling DCI format indicates a duration for skipping PDCCH monitoring. Then, processor 512 may perform, via transceiver 516, PDCCH monitoring based on a setting of the new active DL BWP in a case that the communication apparatus 510 changes to a new active DL BWP of a serving cell by an expiration of a BWP inactive timer in the duration.

In some implementations, processor 512 may detect, via transceiver 516, a scheduling DCI format from the network apparatus 520, wherein the scheduling DCI format indicates a duration for skipping PDCCH monitoring. Then, processor 512 may resume, via transceiver 516, PDCCH monitoring in a case that a HARQ NACK or an UL data is transmitted in the duration.

### Illustrative Processes

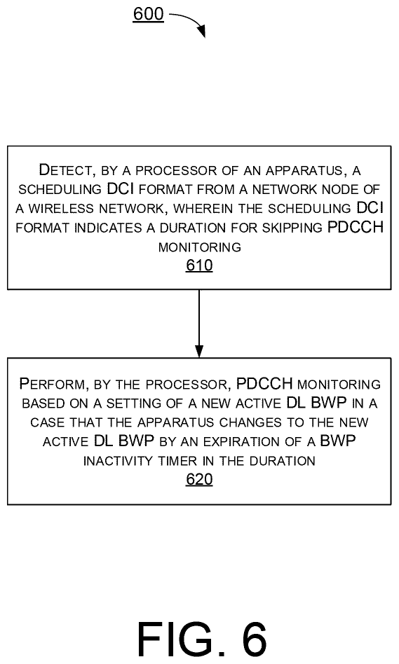

FIG. 6 illustrates an example process 600 in accordance with an implementation of the present disclosure. Process 600 may be an example implementation of above scenarios/schemes, whether partially or completely, with respect to enhancements on PDCCH monitoring adaptation. Process 600 may represent an aspect of implementation of features of communication apparatus 510. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve detecting, by a processor (e.g., processor 512) of an apparatus (e.g., communication apparatus 510), a scheduling DCI format from a network node (e.g., network apparatus 520) of a wireless network, wherein the scheduling DCI format indicates a duration for skipping PDCCH monitoring. Process 600 may proceed from 610 to 620.

At 620, process 600 may involve performing, by the processor (e.g., processor 512), PDCCH monitoring based on a setting of a new active DL BWP in a case that the apparatus (e.g., communication apparatus 510) changes to the new active DL BWP by an expiration of a BWP inactive timer in the duration.

In some implementations, the performed PDCCH monitoring may include resuming, by the processor (e.g., processor 512), PDCCH monitoring according to search space sets on the new active BWP in a case that a list of search space group IDs is not configured.

In some implementations, the performed PDCCH monitoring may include monitoring, by the processor (e.g., processor 512), PDCCH according to search space sets with group index 0 on the new active BWP of the serving cell in a case that the list of search space group IDs is configured.

In some implementations, process 600 may further involve resetting, by the processor (e.g., processor 512), an SSSG timer based on the setting of the new active DL BWP in a case that the apparatus changes to the new active DL BWP by the expiration of the BWP inactive timer in the duration.

In some implementations, the SSSG timer comprises a search space switching timer.

In some implementations, the scheduling DCI format comprises a scheduling DCI format 0_1, 0_2, 1_1, or 1_2.

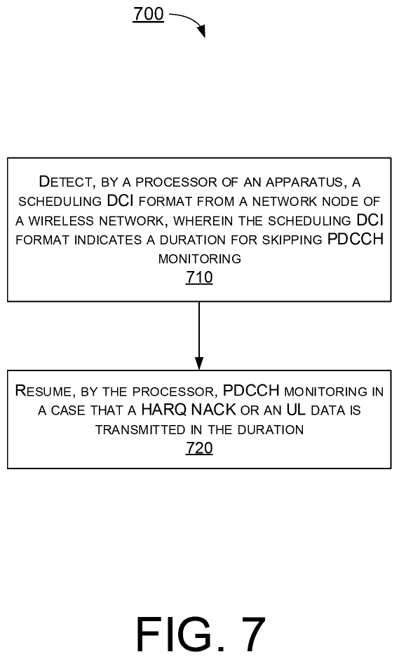

FIG. 7 illustrates an example process 700 in accordance with an implementation of the present disclosure. Process 700 may be an example implementation of above scenarios/schemes, whether partially or completely, with respect to enhancements on PDCCH monitoring adaptation. Process 700 may represent an aspect of implementation of features of communication apparatus 510. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 510 or any suitable UE or machine type devices. Solely for illustrative purposes and without limitation, process 700 is described below in the context of communication apparatus 510. Process 700 may begin at block 710.

At 710, process 700 may involve detecting, by a processor (e.g., processor 512) of an apparatus (e.g., communication apparatus 510), a scheduling DCI format from a network node (e.g., network apparatus 520) of a wireless network, wherein the scheduling DCI format indicates a duration for skipping PDCCH monitoring. Process 700 may proceed from 710 to 720.

At 720, process 700 may involve resuming, by the processor (e.g., processor 512), PDCCH monitoring in a case that a HARQ NACK or an UL data is transmitted in the duration.

In some implementations, the PDCCH monitoring is resumed for another duration.

In some implementations, the PDCCH monitoring is resumed after a timing offset.

In some implementations, the timing offset is used to align with DL or UL traffic.

In some implementations, the timing offset is set to 0.

In some implementations, the HARQ NACK is associated with a PDSCH scheduled by the scheduling DCI format.

In some implementations, the UL data is transmitted on a PUSCH scheduled by the scheduling DCI format.

In some implementations, the scheduling DCI format comprises a scheduling DCI format 0_1, 0_2, 1_1, or 1_2.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
detecting, by a processor of an apparatus, a scheduling downlink control information (DCI) format from a network node of a wireless network, wherein the scheduling DCI format indicates a duration for skipping physical downlink control channel (PDCCH) monitoring; and
performing, by the processor, PDCCH monitoring based on a setting of a new active downlink (DL) bandwidth part (BWP) in a case that the apparatus changes to the new active DL BWP by an expiration of a BWP inactive timer in the duration.

2. The method of claim 1, wherein performing PDCCH monitoring based on the setting of the new active DL BWP comprises:
resuming, by the processor, PDCCH monitoring according to search space sets on the new active BWP in a case that a list of search space group identities (IDs) is not configured.

3. The method of claim 1, wherein performing PDCCH monitoring based on the setting of the new active DL BWP comprises:
monitoring, by the processor, PDCCH according to search space sets with group index 0 on the new active BWP of the serving cell in a case that the list of search space group IDs is configured.

4. The method of claim 1, further comprising:
resetting, by the processor, a search space set group (SSSG) timer based on the setting of the new active DL BWP in a case that the apparatus changes to the new active DL BWP by the expiration of the BWP inactive timer in the duration.

5. The method of claim 4, wherein the SSSG timer comprises a search space switching timer.

6. The method of claim 1, wherein the scheduling DCI format comprises a scheduling DCI format 0_1, 0_2, 1_1, or 1_2.

7. An apparatus, comprising:
a transceiver which, during operation, wirelessly communicates with a network node of a wireless network; and
a processor communicatively coupled to the transceiver such that, during operation, the processor performs operations comprising:
detecting, via the transceiver, a scheduling downlink control information (DCI) format from a network node of a wireless network, wherein the scheduling DCI format indicates a duration for skipping physical downlink control channel (PDCCH) monitoring; and
performing, via the transceiver, PDCCH monitoring based on a setting of a new active downlink (DL) bandwidth part (BWP) in a case that the apparatus changes to the new active DL BWP by an expiration of a BWP inactive timer in the duration.

8. The apparatus of claim 7, wherein performing PDCCH monitoring based on the setting of the new active DL BWP comprises:
resuming, via the transceiver, PDCCH monitoring according to search space sets on the new active BWP in a case that a list of search space group identities (IDs) is not configured.

9. The apparatus of claim 7, wherein performing PDCCH monitoring based on the setting of the new active DL BWP comprises:
monitoring, via the transceiver, PDCCH according to search space sets with group index 0 on the new active BWP of the serving cell in a case that the list of search space group IDs is configured.

10. The apparatus of claim 7, wherein, during operation, the processor further performs operations comprising:
resetting a search space set group (SSSG) timer based on the setting of the new active DL BWP in a case that the apparatus changes to the new active DL BWP by the expiration of the BWP inactive timer in the duration.

11. The apparatus of claim 10, wherein the SSSG timer comprises a search space switching timer.

12. The apparatus of claim 7, wherein the scheduling DCI format comprises a scheduling DCI format 0_1, 0_2, 1_1, or 1_2.

13. A method, comprising:
detecting, by a processor of an apparatus, a scheduling downlink control information (DCI) format from a network node of a wireless network, wherein the scheduling DCI format indicates a duration for skipping physical downlink control channel (PDCCH) monitoring; and
resuming, by the processor, PDCCH monitoring in a case that a hybrid automatic repeat request (HARQ) negative acknowledgement (NACK) or an uplink (UL) data is transmitted in the duration.

14. The method of claim 13, wherein the PDCCH monitoring is resumed for another duration.

15. The method of claim 13, wherein the PDCCH monitoring is resumed after a timing offset.

16. The method of claim 15, wherein the timing offset is used to align with Downlink (DL) or UL traffic.

17. The method of claim 15, wherein the timing offset is set to 0.

18. The method of claim 13, wherein the HARQ NACK is associated with a physical downlink shared channel (PDSCH) scheduled by the scheduling DCI format.

19. The method of claim 13, wherein the UL data is transmitted on a physical uplink shared channel (PUSCH) scheduled by the scheduling DCI format.

20. The method of claim 13, wherein the scheduling DCI format comprises a scheduling DCI format 0_1, 0_2, 1_1, or 1_2.
